(19) United States
(12) Patent Application Publication
(10) Pub. No.: US 2010/0119842 A1
(43) Pub. Date: May 13, 2010

(54) INJECTION PREFORM PLASTIC HAVING SURFACE EFFECT OF METALLIC APPEARANCE

(75) Inventors: Dong-Hyeon HWANG, Gyeonggi-do (KR); Do-Heang KANG, Gyeonggi-do (KR); Yong-Wook HWANG, Gyeonggi-do (KR); Young-Ki KIM, Gyeonggi-do (KR); Shin-Chul KANG, Seoul (KR); Hoon-Soo PARK, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/614,531

(22) Filed: Nov. 9, 2009

(30) Foreign Application Priority Data
Nov. 12, 2008 (KR) 10-2008-0112073

(51) Int. Cl. B32B 27/06; C08F 2/48

(52) U.S. Cl. 428/425.8; 427/510

(57) ABSTRACT

An injection preform providing a metallic texture and a fabrication method thereof, in which on a surface of an injection substrate whereon a thin-film primer coating layer (TPPCL) is formed providing the metallic texture formed with various patterns and to preserve the texture on the surface of the injection substrate. The injection preform typically includes: an injection substrate having a surface on which the various patterns are formed by mold discharge corrosion; a TPPCL formed on the surface of the injection substrate to increase reflectivity of the injection substrate, so that the TPPCL provides the metallic texture with various patterns while preserving surface texture of the injection substrate; a non-conductive metal-deposited layer deposited on a surface of the thin film primer coating layer; a color coating layer (CCL) formed on a surface of the non-conductive metal-deposited layer; and a clear layer formed on a surface of the CCL.

### CLAIM OF PRIORITY

This application claims priority to application entitled “Injection Preform Plastic Having Surface Effect of Metallic Appearance” filed with the Korean Intellectual Property Office on Nov. 12, 2008 and assigned Serial No. 10-2008-0112073, the contents of which are incorporated herein by reference in its entirety.

### BACKGROUND OF THE INVENTION

1. Field of the Invention

The present invention generally relates to a synthetic-resin molded product for the replacement of metal materials and application of a hair-line metallic texture by mold discharge corrosion. More particularly, the present invention relates to an injection preform providing a metallic texture and a fabrication method thereof.

2. Description of the Related Art

Generally, “a portable communication device” refers to a device with which the user can wirelessly communicate with another party. The portable communication device typically includes a hand-held phone (HHP), a cordless telephone generation 2 (CT-2) cellular phone, a digital phone, a personal communications service (PCS) phone, a personal digital assistant (PDA), etc., and is divided into various types based on the external shape of the device. For example, according to the external shape, types of a mobile terminal are divided into a bar-type, a flip-type, or a folder-type mobile terminal. The above enumerated conventional portable terminals necessarily include an antenna device, a data input/output device, and a data transmitting/receiving device. Of course, the data input device generally employs a keypad by which data can be input through finger-pressing of a screen and/or buttons.

Also, the portable communication devices generally include a synthetic resin outer case. Synthetic resin has been used in the replacement of metal materials in fields where metal materials have been conventionally used. Due to the mechanical property of synthetic resins, such as strength, being similar to or better than that of metal materials, their popularity has increased. Especially, as synthetic resin has can be easily changed and is light-weight, compared to metal materials, and thus its application range has been gradually expanded. In addition, a synthetic-resin molded product has the characteristic of high surface gloss.

Meanwhile, a synthetic resin material having the above-mentioned characteristics can be applied to various products in the replacement of metal materials due to its advantages in terms of strength and light-weight. However, while synthetic resin has the aforementioned advantages, there is a disadvantage in that synthetic resin has a texture that is poorer than that of metal materials.

Accordingly, in an attempt to bypass the disadvantage regarding the texture of the synthetic resin on the surface of the synthetic resin material and the metal material, in the conventional art a hair-line metallic texture, which is generally referred to in the art as a “hair-line” was applied by mold discharge corrosion. Herein, a metallic texture is referred to as a hair-line. Note that the term, “mold discharge corrosion”, indicates a process of forming various patterns on a surface of an injection preform by corroding a surface of an electrode by heat due to a discharge, electronic or mechanical power, which belongs to a conventional art.

However, such formation of the hair-line on the metal material cannot meet the customer's demand for various patterns due to the limited changeable range of the hair-line patterns, and also there are limitations in applying the hair-line to the exterior of a communication device, because the hair-line can reduce/adversely affect the performance of an antenna.

Also, there is a disadvantage in that after the injection of the synthetic resin material, the finishing cannot be perfectly completed.

In order to overcome the aforementioned disadvantages, there is a long-felt need in the art to coat the surface of the synthetic resin material and the metal material with a thin film primer.

### SUMMARY OF THE INVENTION

Accordingly, the present invention provides an injection preform providing a metallic texture and a fabrication method thereof, in which on the surface of an injection substrate, a thin film primer coating layer is formed to express a metallic texture formed with various patterns and to preserve the texture on the surface of the injection substrate. The injection preform according to the present invention is freely applicable to the exterior of a variety of products, and thus, improves the exterior appearance of products and meets the consumer demand for products with a variety of different textures. Also, it is possible to secure the reliability and mass production of products having at least the aforementioned advantages via the injection preform of the present invention.

Also, the present invention provides an injection preform providing a metallic texture and a fabrication method thereof, in which a non-conductive metal-deposited layer is formed on the surface of the injection substrate, so as not to have an impact on the performance of the antenna provided in the product.

In accordance with an exemplary aspect of the present invention, there is provided an injection preform providing a metallic texture, the injection preform including: an injection substrate having a surface on which various patterns are formed by mold discharge corrosion; a thin film primer coating layer, which is formed on the surface of the injection substrate for increasing reflectivity of the surface of the injection substrate, so that the thin film primer coating layer expresses a metallic texture with the various patterns while preserving surface texture of the injection substrate; a non-conductive metal-deposited layer deposited on a surface of the thin film primer coating layer; a color coating layer formed on a surface of the non-conductive metal-deposited layer; and a clear layer formed on a surface of the color coating layer.

Also, the thin film primer coating layer may include an oligomer, a monomer, an initiator, a leveling agent, and a solvent.

Also, the thin film primer coating layer preferably has a non-volatile content of 17.6%, which is generally about one third of a non-volatile content (48.6%) of an existing conventional injection preform.

Also, a component of the oligomer preferably includes a hard-type urethane acrylate or soft-type urethane acrylate.

Also, in the component of the oligomer, a content of the hard-type urethane acrylate may comprise about 7%, which is higher than a typical content (4.5%) of an existing conventional injection preform, and a content of the soft-type urethane acrylate may comprise about 1.5%, which is lower than a typical content (21%) of the existing conventional injection preform.

Also, the non-conductive metal-deposited layer preferably includes a tin (Sn) deposited layer.

Also, the injection substrate preferably includes one of acryl, polycarbonate (PC), and Polyethylene terephthalate (PET).

Also, the clear layer preferably includes an ultraviolet (UV) coated layer.

In accordance with another exemplary aspect of the present invention, there is provided a method of fabricating an injection preform with a metallic texture, the method including the steps of: forming various patterns on an injection substrate by mold discharge corrosion; forming a thin film primer coating layer on a surface of the injection substrate, the thin film primer coating layer for showing a metallic texture with the various patterns while preserving surface texture of the injection substrate, by increasing reflectivity of the surface of the injection substrate; forming a non-conductive metal-deposited layer on a surface of the thin film primer coating layer; forming a color coating layer on a surface of the non-conductive metal-deposited layer; and forming a clear layer on a surface of the color coating layer.

Also, the thin film primer coating layer preferably includes an oligomer, a monomer, an initiator, a leveling agent, and a solvent.

Also, the thin film primer coating layer preferably has a non-volatile content of substantially 17.6%, which is about one third of a non-volatile content (48.6%) of an existing conventional injection preform.

Also, a component of the oligomer preferably includes a hard-type urethane acrylate or soft-type urethane acrylate.

Also, in the component of the oligomer, a content of the hard-type urethane acrylate is 7%, which is typically higher than a content (4.5%) of an existing conventional injection preform, and a content of the soft-type urethane acrylate is substantially 1.5%, which is typically lower than a content (21%) of the existing conventional injection preform.

Also, the non-conductive metal-deposited layer preferably includes a tin (Sn) deposited layer.

Also, the injection substrate preferably includes acryl, polycarbonate (PC), and Polyethylene terephthalate (PET).

Also, the clear layer preferably includes a UV layer.

### BRIEF DESCRIPTION OF THE DRAWINGS

The above and other exemplary features, aspects, and advantages of the present invention will become more apparent from the following detailed description taken in conjunction with the accompanying drawings, in which:

FIG. 1 is a plan view illustrating an injection preform providing a metallic texture, according to an exemplary embodiment of the present invention;

FIG. 2 is an enlarged cross-sectional view of part A as shown in FIG. 1; and

FIG. 3 is a flow chart illustrating exemplary steps of a method of fabricating an injection preform providing a metallic texture, according to an exemplary embodiment of the present invention.

### DETAILED DESCRIPTION

Hereinafter, exemplary embodiments of the present invention will be described in detail with reference to the accompanying drawings. However, the following examples are illustrative only, and the scope of the present invention is not limited to the illustrative examples shown and described. Those skilled in the art will appreciate that various modifications, additions and substitutions are possible, without departing from the spirit of the invention and the scope of the appended claims.

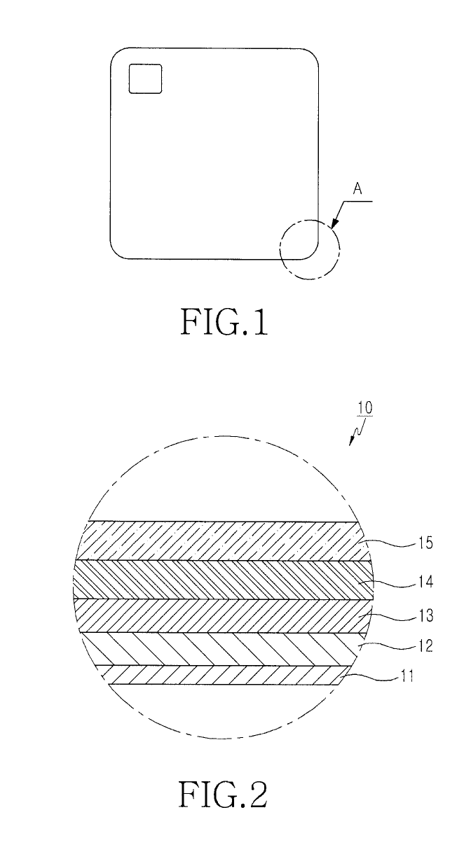

As shown in FIGS. 1 and 2, an injection preform 10 with a metallic texture includes an injection substrate 11, a thin film primer coating layer 12, a non-conductive metal-deposited layer 13, a color coating layer 14, and a clear layer 15. In this example, these layers are successively directly deposited one upon another, however it is possible that there could be additional intervening layers thereon or there between.

On the surface of the injection substrate 11, various patterns with a metallic texture (hair-line) are formed by mold discharge corrosion.

The thin film primer coating layer 12 is preferably formed on the surface of the injection substrate 11, which increases reflectivity of the surface of the injection substrate 11 to express the metallic texture with various patterns and to preserve the surface texture of the injection substrate.

The non-conductive metal-deposited layer 13 is preferably deposited on the surface of the thin film primer coating layer 12 so as not to have an influence on the performance of the antenna provided in the product.

The color coating layer 14 is preferably formed on the surface of the non-conductive metal-deposited layer 13 so as to further enhance the metallic texture of the injection substrate 11.

The clear layer 15 is preferably formed on the surface of the color coating layer 14 so as to protect the coating layers.

The thin film primer coating layer 12 preferably includes an oligomer, a monomer, an initiator, a leveling agent, and a solvent.

The thin film primer coating layer 12 has a nonvolatile content of substantially 17.6%, which is about one third of that (48.6%) of a conventional injection preform.

The component of the oligomer preferably includes a hard-type urethane acrylate or soft-type urethane acrylate. Herein, the content of the hard-type urethane acrylate is substantially 7%, which is higher than that (4.5%) of the conventional injection preform, and the content of the soft-type urethane acrylate is substantially 1.5%, which is lower than that (typically 21%) of the conventional injection preform. Meanwhile, the non-conductive metal-deposited layer 13 preferably includes a tin (Sn) deposited layer.

Note that the component of the oligomer preferably includes both a hard-type urethane acrylate and soft-type urethane acrylate in the present invention to enhance the expression of the metallic texture, and preserve the surface texture of the injection substrate.

The injection substrate 11 preferably includes acryl, PC, and PET, and the clear layer 15 includes a UV layer.

Hereinafter, the operation of an exemplary process of the injection preform providing a metallic texture, according to a preferred exemplary embodiment of the present invention, as configured above, will be described in more detail with reference to FIGS. 1 and 2.

As shown in FIGS. 1 and 2, in the injection preform 10 with a metallic texture, in which various patterns with a metallic texture (hair-line) are formed on the surface of the injection substrate 11 by mold discharge corrosion, and then the thin film primer coating layer 12 is formed on the surface of the injection substrate 11, the thin film primer coating layer 12 being for providing a metallic texture with various patterns and preserving the surface texture of the injection substrate 11 by increasing reflectivity of the injection substrate 11.

On the surface of the thin film primer coating layer 12, the non-conductive metal-deposited layer 13 is preferably formed, on the surface of the non-conductive metal-deposited layer 13, the color coating layer 14 is preferably formed, and on the surface of the color coating layer 14, the clear layer 15 is preferably formed.

The thin film primer coating layer 12, when formed, improves the finishing following the injection molding of the injection substrate 11, and also enhances the expression of the metallic texture, and preserves the surface texture of the injection substrate by increasing the reflectivity.

Herein, the injection substrate 11 includes acryl, PC, and PET, and the clear layer 15 includes a UV layer.

The thin film primer coating layer 12 includes an oligomer, a monomer, an initiator, a leveling agent, and a solvent, and its coating material composition is noted in Table 1.

Also, as noted in Table 1, the thin film primer coating layer 12 has a non-volatile content of substantially 17.6%, which is about one third of that (substantially 48.6%) of the conventional injection preform.

Also, the component of the oligomer includes a hard-type urethane acrylate or soft-type urethane acrylate. Herein, the content of the hard-type urethane acrylate is substantially 7%, which is higher than that (4.5%) of the conventional injection preform, and the content of the soft-type urethane acrylate is substantially 1.5%, which is lower than that (21%) of the conventional injection preform.

Also, the content of the monomer is substantially 3.5%, which is lower than that (10.5%) of the conventional injection preform.

TABLE 1
Thin-Film Primer Composition

| Composition | Component | Prior Art | Improved | Remarks |
|---|---|---|---|---|
| oligomer | hexafunctional | 4.5% | 7% | hard type |
| | urethane acrylate | | | |
| | bifunctional urethane | 21% | 1.5% | soft type |
| | acrylate | | | |
| monomer | bifunctional monomer | 10.5% | 3.5% | |
| | multifunctional | 10.5% | 3.5% | |
| | monomer | | | |
| solvent | hydro carbon | 25% | 40% | |
| | ester | 25% | 40% | |
| | ketone | 1.4% | 2.4% | |
| additive | photoinitiator | 2% | 2% | |
| | leveling agent | 0.1% | 0.1% | |
| | matting agent | | | |

| | | |
|---|---|---|
| Total | 100% | 100% |
| NV (Non-Volatile) content | 48.6% | 17.6% |

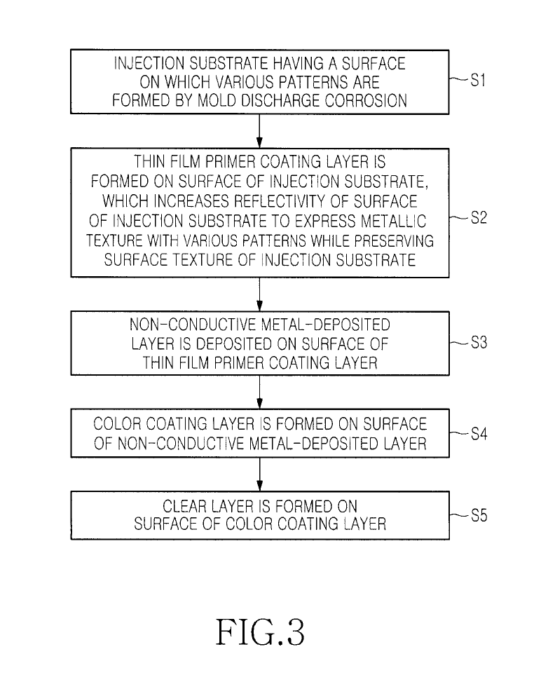

Hereinafter, a method of fabricating the injection preform providing a metallic texture, according to a preferred exemplary embodiment of the present invention, as configured above, will be described in more detail with reference to FIG. 3.

Referring to the flowchart in FIG. 3, in a fabrication method of the injection preform providing a metallic texture, on an injection substrate 11, various patterns of hair-lines are formed by mold discharge corrosion (S1).

Then, on the surface of the injection substrate 11, a thin film primer coating layer 12 is formed (S2), such that the thin-film primer coating layer 12 for providing a metallic texture with various patterns and preserving the surface texture of the injection substrate 11 by increasing reflectivity.

Then, on the surface of the thin-film primer coating layer 12, a non-conductive metal-deposited layer 13 including a tin (Sn) deposited layer is formed (S3).

Subsequently, on the surface of the non-conductive metal-deposited layer 13 formed, a color coating layer 14 is formed so as to further enhance the metallic texture of the injection substrate 11 (S4).

Finally, on the surface of the color coating layer 14, a clear layer 15 including a UV layer is formed so as to protect the coating layers of the injection substrate 11 (S5).

Herein, the injection substrate 11 preferably includes acryl, PC, and PET, and the clear layer 15 preferably includes a UV layer.

The thin-film primer coating layer 12 includes an oligomer, a monomer, an initiator, a leveling agent, and a solvent, and its coating material composition is noted in Table 1.

Also, as noted in Table 1, the thin-film primer coating layer 12 has a non volatile content of 17.6%, which is about one third of that (48.6%) of the conventional injection preform.

In addition, the component of the oligomer preferably includes a hard-type urethane acrylate or soft-type urethane acrylate. Herein, the content of the hard-type urethane acrylate is substantially 7%, which is higher than that (4.5%) of the conventional injection preform, and the content of the soft-type urethane acrylate is substantially 1.5%, which is lower than that (21%) of the conventional injection preform.

Also, the content of the monomer is substantially 3.5%, which is lower than that (10.5%) of the conventional injection preform.

While the injection preform providing a metallic texture and a fabrication method thereof, according to the present invention, have been shown and described with reference to certain exemplary embodiments and drawings, it will be understood by those skilled in the art that various changes in form and details may be made therein without departing from the spirit and scope of the invention as defined by the appended claims.

What is claimed is:

1. An injection preform providing a metallic texture, the injection preform comprising:
an injection substrate having a surface on which one or more patterns are formed;
a thin-film primer coating layer formed on the surface of the injection substrate for increasing reflectivity of the surface of the injection substrate, wherein said thin-film primer coating layer visually enhancing the metallic texture of the one or more patterns while preserving a surface texture of the injection substrate;
a non-conductive metal-deposited layer deposited on a surface of the thin film primer coating layer;
a color coating layer formed on a surface of the non-conductive metal-deposited layer; and
a clear layer formed on a surface of the color coating layer.

2. The injection preform as claimed in claim 1, wherein the thin-film primer coating layer comprises an oligomer, a monomer, an initiator, a leveling agent, and a solvent.

3. The injection preform as claimed in claim 2, wherein the thin-film primer coating layer includes a non-volatile content of substantially 17.6%.

4. The injection preform as claimed in claim 3, wherein said non-volative content about one third of a non-volatile content (48.6%) of an existing injection preform shown in TABLE 1:
TABLE 1
Thin film primer composition

| composition | component | prior art | improved | remarks |
|---|---|---|---|---|
| oligomer | hexafunctional | 4.5% | 7% | hard type |
| | urethane acrylate | | | |
| | bifunctional urethane | 21% | 1.5% | soft type |
| | acrylate | | | |
| monomer | bifunctional monomer | 10.5% | 3.5% | |
| | multifunctional | 10.5% | 3.5% | |
| monomer | | | | |
| solvent | hydro carbon | 25% | 40% | |
| | ester | 25% | 40% | |
| | ketone | 1.4% | 2.4% | |
| additive | photoinitiator | 2% | 2% | |
| | leveling agent | 0.1% | 0.1% | |
| | matting agent | | | |
| | | | |
|---|---|---|---|
| Total | 100% | 100% | |
| NV (Non-Volatile) content | | 48.6% | 17.6% |

5. The injection preform as claimed in claim 2, wherein a component of the oligomer comprises one of a hard-type urethane acrylate or soft-type urethane acrylate.

6. The injection preform as claimed in claim 5, wherein in the component of the oligomer, a content of the hard-type urethane acrylate comprises substantially 7%, and a content of the soft-type urethane acrylate is substantially 1.5%.

7. The injection preform as claimed in claim 5, wherein in the component of the oligomer, a content of the hard-type urethane acrylate comprises substantially 7%, which is higher than a content (4.5%) of an existing injection preform shown in TABLE 1, and a content of the soft-type urethane acrylate is substantially 1.5% which is lower than a content (21%) of the existing injection preform shown in TABLE 1:
TABLE 1
Thin film primer composition

| composition | component | prior art | improved | remarks |
|---|---|---|---|---|
| oligomer | hexafunctional | 4.5% | 7% | hard type |
| | urethane acrylate | | | |
| | bifunctional urethane | 21% | 1.5% | soft type |
| | acrylate | | | |
| monomer | bifunctional monomer | 10.5% | 3.5% | |
| | multifunctional | 10.5% | 3.5% | |
| | monomer | | | |
| solvent | hydro carbon | 25% | 40% | |
| | ester | 25% | 40% | |
| | ketone | 1.4% | 2.4% | |
| additive | photoinitiator | 2% | 2% | |
| | leveling agent | 0.1% | 0.1% | |
| | matting agent | | | |
| | | |
|---|---|---|
| Total | 100% | 100% |
| NV (Non-Volatile) content | 48.6% | 17.6% |

8. The injection preform as claimed in claim 1, wherein the non-conductive metal-deposited layer comprises a tin (Sn) deposited layer.

9. The injection preform as claimed in claim 1, wherein the injection substrate comprises acryl, polycarbonate (PC), and Polyethylene terephthalate (PET).

10. The injection preform as claimed in claim 1, wherein the clear layer comprises a ultraviolet (UV) layer.

11. A method of fabricating an injection preform providing a metallic texture, the method comprising the steps of:
forming one or more patterns on an injection substrate;
forming a thin-film primer coating layer on a surface of the injection substrate, the thin-film primer coating layer showing the metallic texture with the one or more patterns while preserving a surface texture of the injection substrate and by increasing reflectivity of the surface of the injection substrate;
forming a non-conductive metal-deposited layer on a surface of the thin-film primer coating layer;
forming a color coating layer on a surface of the non-conductive metal-deposited layer; and
forming a clear layer on a surface of the color coating layer.

12. The method as claimed in claim 11, wherein the thin-film primer coating layer comprises an oligomer, a monomer, an initiator, a leveling agent, and a solvent.

13. The method as claimed in claim 11, wherein the thin-film primer coating layer has a non volatile content of substantially 17.6%.

14. The method as claimed in claim 12, wherein a component of the oligomer comprises one of a hard-type urethane acrylate or soft-type urethane acrylate.

15. The method as claimed in claim 14, wherein in the component of the oligomer, a content of the hard-type urethane acrylate is substantially 7%, and a content of the soft-type urethane acrylate is substantially 1.5%.

16. The method as claimed in claim 11, wherein the non-conductive metal-deposited layer comprises a tin (Sn) deposited layer.

17. The method as claimed in claim 11, wherein the injection substrate comprises acryl, polycarbonate (PC), and Polyethylene terephthalate (PET).

18. The method as claimed in claim 11, wherein the clear layer comprises an ultraviolet (UV) layer.
